(19) United States
(12) Patent Application Publication
(10) Pub. No.: US 2007/0129654 A1
(43) Pub. Date: Jun. 7, 2007

(54) THERAPEUTIC ROLLER

(76) Inventor: James Anderson JR., Franklin, MA (US)

Correspondence Address: R.D. JOHNSON & ASSOCIATES, P.C., 20 PICKERING STREET, P.O.BOX 920353, NEEDHAM, MA, 02492, US

(21) Appl. No.: 11/549,446

(22) Filed: Oct. 13, 2006

Related U.S. Application Data
(60) Provisional application No. 60/726,444, filed on Oct. 13, 2005.

(51) Int. Cl. A61H 15/00

(52) U.S. Cl. 601/119; 601/118; 601/134; 601/136

(57) ABSTRACT

A therapeutic roller can be used to apply a therapeutic message to a person's extremity, such as the hand or foot. In particular, a therapeutic roller device comprises an inner tube member, a textured tube member, and a mechanism for removably securing the textured tube member to the inner tube member so that the textured tube member can be easily removed and replaced with a new or different textured tube member. In particular, the textured tube member has elastic properties to facilitate removal and installation of the textured tube. In addition, the therapeutic roller can be used to provide thermal treatment to a patient.

### RELATED APPLICATION(S)

This application claims the benefit of U.S. Provisional Application No. 60/726,444, filed on Oct. 13, 2005 (Docket No. 3909.1000-000), the teachings of which are incorporated herein by reference.

### BACKGROUND

Various roller devices have been shown useful for massaging or stimulating the feet and other body parts of users. A typical roller is made from wood into which elevated bumps or other surface textures may be carved. Wooden rollers are typically sold to consumers for casual home use by an individual or a family. While suitable for casual use, wooden rollers are not a good choice for patients suffering from more severe ailments.

It is also known that thermal therapy can alleviate some symptoms. In particular, thermally-assisted therapeutic relief can be applied to reduce inflammation due to trauma or an inflammatory condition. Unfortunately, wooden rollers do not maintain heat or cold for a significant period of time. Instead, wooden rollers are typically used at room temperature.

### SUMMARY

A therapeutic roller in accordance with aspects of the invention can be used to apply a therapeutic massage to a person's extremity, such as the hand or foot. The therapeutic roller is particularly indicated for relief of bunions, plantar fasciitis, bursitis, rheumatoid arthritis, osteo arthritis, traumatic arthritis, post surgery edema, tendonitis, sesamoiditis, neuromas, ganglion cyst (fluid filled cyst), diabetic neuropathy, Tailor's bunion, venous insuffency, pes planus, pes cavus, metatarsalgia, dislocations, and general pain in the extremities.

In accordance with aspects of the invention, a therapeutic roller can be used to treat multiple clinical patients. Each patient may respond most favorably to a particular texture structure or patterns. Consequently, the therapeutic roller can be adaptable by a clinician to suit a particular patient's needs.

Furthermore, at least some patients are obese due to diabetes or other conditions. The materials used for the roller and the roller's construction are therefore selected to handle frequent use under heavy loads.

In accordance with an aspect of the invention, a therapeutic roller device comprises an inner tube member, a textured tube member, and a mechanism for removably securing the textured tube member to the inner tube member. In particular, the inner tube member provides structural support.

The inner tube member can include an interior cavity accessible by a user. The interior cavity can be filled with a thermal material such as water to apply heat or cold to the device. Furthermore, the inner tube member can have two interior cavities that can be heated to different temperatures.

The mechanism that removably secures the textured tube member to the inner tube member can include a keyed joint between the inner tube member and the textured tube member. The keyed joint can be a tongue-and-groove joint. The mechanism can also include an end cap.

In a particular embodiment, the inner tube member can be fabricated from stainless steel or another suitably strong material. The textured tube member can be fabricated from a rigid material (e.g., metal or plastic) or from an elastomeric material. In another embodiment, the textured tube member can include a plurality of textured rings arranged in a sequence. The textured tube member can further be filled with a thermal-retentive material such as a thermal gel or beads that can be heated or chilled prior to installation on the inner tube member.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a particular therapeutic roller device

FIG. 2 is a cross-sectional view of the roller assembly of FIG. 1.

FIG. 3 is an end view of the inner tube 10 of FIG. 1.

FIG. 4 is a cross-sectional view taken along line A-A of FIG. 3.

FIG. 5 is a perspective view of a textured ring, a plurality of which are arranged in sequence to form the textured surface of FIG. 1.

FIG. 6 is a cross-sectional view of the textured ring of FIG. 5.

FIG. 7 is a cross-sectional view of the end cap of FIG. 2.

### DETAILED DESCRIPTION

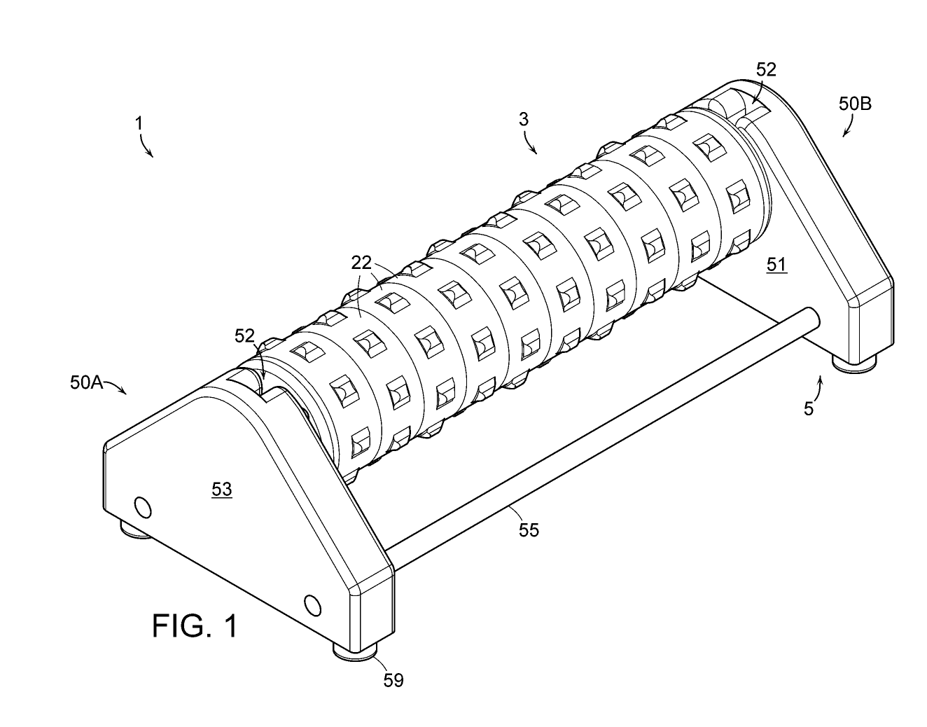

FIG. 1 is a perspective view of a particular therapeutic roller device 1. As shown, the device 1 includes a roller assembly 3 supported by a stand assembly 5. The roller assembly 3 has a textured surface, shown as a plurality of rings 22. Although a specific texture pattern is shown, other texture patterns can be employed and are anticipated. Further details of the roller assembly 3 will be described below.

The stand assembly 5 includes a pair of stand mounts 50A, 50B, each of which has a respective inner surface 51 and a respective outer surface 53. The roller assembly 3 mounts to the stand mounts 50A, 50B via respective mounting channels 52. The stand mounts 50A, 50B are connected by a connecting rods 55, which help stabilize the stand assembly 5. Also shown are foot pads 59. In accordance with a particular embodiment, the stand mounts are fabricated from a solid block of stainless steel, although other suitably strong materials can be used. Other stand structures can be used, as would be known of those of ordinary skill in the art.

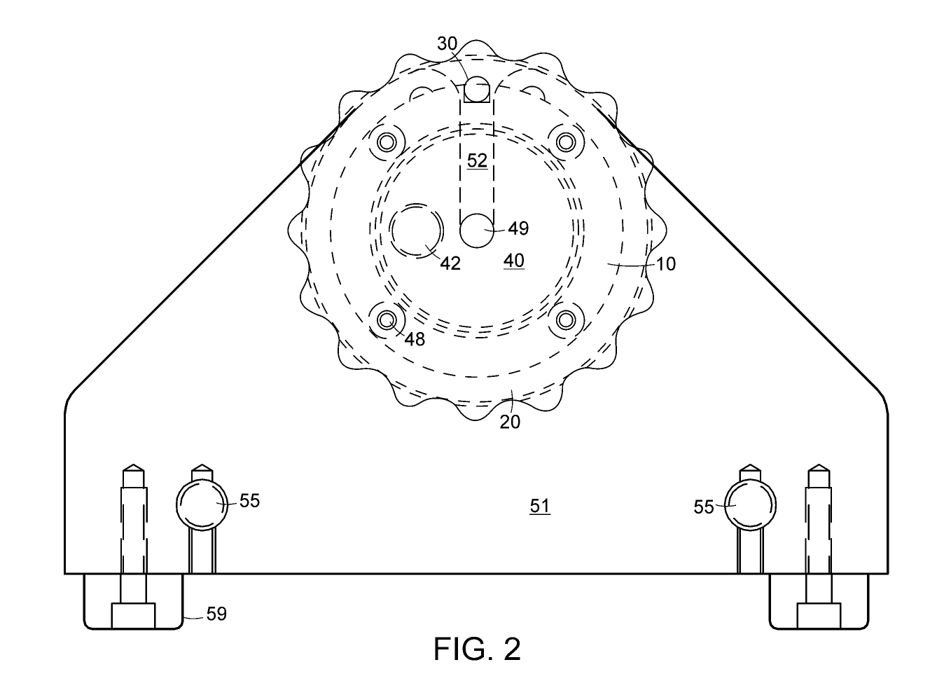

FIG. 2 is a cross-sectional view of the roller assembly 3 of FIG. 1. As shown, the roller assembly 3 is formed around an structural inner tube member 10. The inner tube member 10 is the main structural element of the roller 3 and is expected to support the weight of an obese patient (around 350 pounds). The inner tube member 10 can be made from stainless steel or other suitably strong materials.

Around the inner tube 10 is an outer textured tube member 20, which can be a sequence of contoured rings (as shown in FIG. 1) or a single tube structure. In another embodiment, a textured surface can be fabricated directly on the inner tube member 10 so that a separate component would not be required. However, by utilizing a textured surface separable from the inner tube 10, the textured surface can be changed or replaced.

The inner tube 10 and the textured surface 20 are fixed relative to each other by a key rod 30. As will be described in further detail below, the key rod is registered to a key channel on the inner tub 10 and to a key groove on the textured surface 20. In another embodiment, the function of the key rod can be incorporated into either the outer rings/tubes 20, such as a tongue-and-groove coupling.

Also shown is an end cap 40. The end cap 40 is fastened to the inner tube member 10 with screws 48 and is rotatably connected to the stand mounts 50 via mounting pins 49. The end cap 40 is shown with an access port 42. The access port 42 is sealable to allow heated or chilled fluid to be poured into the inner tube 10. The heat/cold in combination with the textured surface can provide therapeutic benefits to a patient.

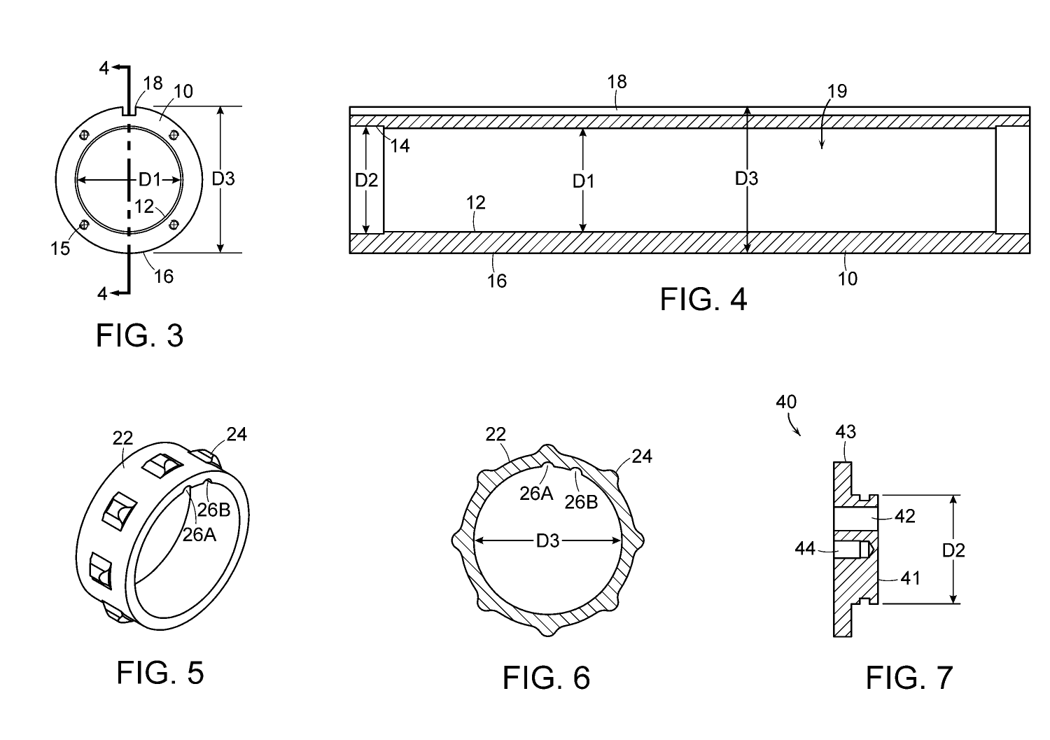

FIG. 3 is an end view of the inner tube 10 of FIG. 1. The inner tube 10 has an inner surface 12 with an inner diameter of D1 and an outer surface 16 with an outer diameter of D3. In a particular embodiment, the inner diameter D1 is about 1.5 inches and the outer diameter D3 is about 2 inches, the exact dimensions however are not critical. As shown, the outer surface 16 includes a key channel 18 that runs along the length of the inner tube 10. Also shown are screw holes 15 for receiving the end cap screws 48 (FIG. 2).

FIG. 4 is a cross-sectional view taken along line A-A of FIG. 3. The inner tube 10 is 10 inches long. As shown, a step 14 of diameter D2 is formed at the ends of the inner tube 10. The step is used to seat the end cap 40 (FIG. 2). In a particular embodiment, the inner tube member is fabricated from a stainless steel tube having a about a 0.25 inch wall thickness.

With the end caps 40 seated, an interior cavity 19 in the inner tube 10 can be filled with a liquid, such as heated or chilled water. The metal inner tube 10 conducts heat between the patient and the liquid. It is understood that the inner tube member 10 need not be a true tube. Instead, the inner tube member 10 can be fabricated from bar stock and be divided or bisected into two cavities, each accessible through the adjacent end cap 40 to allow for the introduction of two water temperatures (e.g., one hot and one cold).

FIG. 5 is a perspective view of a textured ring 22, a plurality of which are arranged in sequence to form the textured surface 20 of FIG. 1. Texture features 24 are arranged on the outer surface of the ring 22. As shown, the texture features 24 are annularly spaced along the circumference of the ring 22. In the particular texture shown, each elevated texture feature is offset from its adjacent texture features by 45 degrees. The inner surface of the ring includes two key grooves 26A, 26B, one of which is aligned with the key channel 18 of the inner tube 10 and receives the key rod 30.

FIG. 6 is a cross-sectional view of the textured ring 22 of FIG. 5. The ring 22 has an inner diameter of D3 and slides over the outer surface 16 of the inner tube 10. Note that one key groove 26A is aligned with a texture feature 24, while the other key groove 26B is offset by one-half of the angular distance to the next adjacent texture feature (22.5 degrees in the illustrated embodiment). When the rings 22 are installed, alternating key grooves 26 are aligned with the key channel 18 of the inner tube 10. That alternating arrangement yields the texture pattern shown in FIG. 1.

In another embodiment, each ring 22 has a single key groove 26 that is spaced one-forth the distance between adjacent texture features 24 (11.25 degrees in the illustrated embodiment). When installed, each ring 22 is flipped relative to the adjacent ring 22. The resulting texture pattern would match that shown in FIG. 1.

FIG. 7 is a cross-sectional view of the end cap 40 of FIG. 2. The end cap 40 includes a neck portion 41 that is dimensioned to be received in the step 14 of the inner tube 10 (FIG. 4) and a flange portion 43 having a diameter equal to at least the diameter of the inner tube D3 to lock the key rod 30 into place. An o-ring (not shown) maintains a watertight seal. Water or another heated or chilled fluid can be introduced into the interior cavity 19 (FIG. 4) through the access port 42, which can be temporarily sealed. The end cap is secured to the inner tube by screws 49 (FIG. 2) and locks the rings in place.

As shown, the end cap 40 includes a coaxial bore 44 into, but not through the end cap. This bore 44 receives a mounting pin 49 (FIG. 2) for rotatably mounting the roller assembly to the mount stands 50. In another embodiment, the end cap 40 can be fabricated to have an integrated mounting lug extending coaxially from the end cap, instead of a separate pin.

In the illustrated embodiment, the textured rings 22 can be removed and replaced with other rings, which may have the same or a different texture. To remove the rings, at least one end cap is removed and the rings are slid off

In another embodiment, the end cap diameter can be reduced to less than the diameter of the inner tube (less than D3). A collar can be threaded onto the outer diameter of the end cap to longitudinally secure the rings. Such an embodiment permits quicker changing of the textured surface.

In another particular embodiment, the textured surface is an elastomeric tube with a textured outer surface. Such a tube could be fitted onto the inner tube without requiring the removal of end caps or collars. Because the outer tube would be remain somewhat elastic after being positioned, more than one key channel may be desired, such as three or five annularly spaced key channels. Also because the elastomeric tube would be molded or extruded, mating tongues could be formed on the inside of the textured tube. When installed the formed tongues would be positioned into respective key channels. The use of textured elastomeric tubes would permit easy replacement of textures, such as may be required from patient to patient.

The elastomeric tube can be thin or thick. A thinner elastomeric tube would function like a skin on the inner tube 10. A thicker elastomeric tube can be filled with a thermal-retentive material (such as a gel or beads) that can then be heated or chilled prior to installation.

While this invention has been particularly shown and described with references to particular embodiments, it will be understood by those skilled in the art that various changes in form and details may be made to the embodiments without departing from the scope of the invention encompassed by the appended claims.

What is claimed is:

1. A therapeutic roller device comprising:
an inner tube member;
a textured tube member; and
a mechanism for removably securing the textured tube member to the inner tube member.

2. The device of claim 1 wherein the inner tube member includes an interior cavity accessible by a user.

3. The device of claim 1 wherein the mechanism includes a keyed joint between the inner tube member and the textured tube member.

4. The device of claim 3 wherein the keyed joint is a tongue-and-groove joint.

5. The device of claim 1 wherein the mechanism includes an end cap.

6. The device of claim 1 wherein the textured tube member is made from an elastomeric material.

7. The device of claim 1 wherein the textured tube member is filled with a thermal-retentive material.

8. The device of claim 1 wherein the textured tube member includes a plurality of textured rings arranged in a sequence.

9. A therapeutic roller device comprising:
an inner structural tube member for supporting the weight of a user;
a textured elastomeric tube member;
a mechanism for removably securing the textured elastomeric tube member to the inner structural tube member, the mechanism comprising:
a longitudinal joint to annularly fix the textured tube member relative to the inner tube member; and
an opposing pair of end caps to longitudinally fix the textured tube member relative to the inner tube member.

10. The device of claim 9 wherein the inner tube member includes an interior cavity accessible by a user through at least one end cap.

11. The device of claim 9 wherein the longitudinal joint includes a tongue-and-groove joint.

12. The device of claim 9 wherein the textured elastomeric tube member is filled with a thermal-retentive material.

13. A method of fabricating a therapeutic roller device, comprising:
fabricating an inner tube member;
fabricating a textured tube member; and
removably securing the textured tube member to the inner tube member.

14. The method of claim 13 wherein the inner tube member includes an interior cavity accessible by a user.

15. The method of claim 13 wherein removably securing comprising fabricating a keyed joint between the inner tube member and the textured tube member.

16. The method of claim 15 wherein the keyed joint is a tongue-and-groove joint.

17. The method of claim 13 wherein the removably securing includes coupling an end cap to the inner tube member.

18. The method of claim 13 wherein the textured tube member is fabricated from an elastomeric material.

19. The method of claim 13 wherein the textured tube member includes a plurality of textured rings arranged in a sequence.

20. The method of claim 13 further comprising filling the textured tube member with a thermal-retentive material.
